(19) United States
(12) Patent Application Publication
(10) Pub. No.: US 2019/0050201 A1
(43) Pub. Date: Feb. 14, 2019

(54) CONFIGURABLE DATA STREAM AGGREGATION FRAMEWORK

(71) Applicant: Facebook, Inc., Menlo Park, CA (US)

(72) Inventors: Mark Aaron Roberts, Fremont, CA (US); Aliaksei Kolesau, Minsk (BY); Terence Joseph Kivran-Swaine, Menlo Park, CA (US); Justin Grant, Redwood City, CA (US); Sagar Kuverji Savla, Cupertino, CA (US); Bharathy Sripadham, Menlo Park, CA (US)

(21) Appl. No.: 15/672,214

(22) Filed: Aug. 8, 2017

(51) Int. Cl. G06F 7/38; G06F 3/06

(52) U.S. Cl. CPC G06F 7/38; G06F 17/30442; G06F 3/0659

(57) ABSTRACT

A configurable data stream aggregation system and method that enables formatting, processing, and aggregation of incoming streams of data is disclosed herein. The system receives one or more streams of incoming data and determines their format (data stream definition). The system also determines the data stream definition of the output stream of data. Based on the input stream definition and the output stream definition, the system selects one or more data operations that will be used to generate the measure/aggregate values in the output stream. The selected data operations are then executed on the input data streams to generate one or more measures/aggregates of the output data stream(s) in the output stream format(s). The output data stream(s) can then be streamed to one or more systems (internal or external).

### BACKGROUND

Organizations have to make quick and decisive actions on a large volume of incoming information. The volume of information that is available to organizations is increasing at an exponential rate. In fact, some large organizations process several zettabytes of data on a regular basis. Thus, it is essential for organizations to be able to effectively and optimally process the tremendous volume of incoming data to yield metrics and aggregates that can then be used to make intelligent business decisions.

Traditionally, organizations create data warehouses to store and manage these volumes of data. A data warehouse provides a single or multiple central locations where a reconciled version of data extracted from a wide variety of incoming data sources is stored. Once a data warehouse is created, organizations can then employ decision support systems, such as On-Line Analytical Processing (OLAP) systems, that allow users to intuitively, quickly, and flexibly manipulate operational data using familiar business terms, in order to provide analytical insight into a particular problem or line of inquiry. For example, by using an OLAP system, decision makers can “slice and dice” information along a customer (or business) dimension, and view business metrics by product and through time. Reports can be defined from multiple perspectives that provide a high-level or detailed view of the performance of any aspect of the business. Decision makers can navigate throughout their database by drilling down on a report to view elements at finer levels of detail, or by pivoting to view reports from different perspectives.

One particular application of decision support systems is in the field of market targeting. Market targeting and market segmentation applications involve extracting highly qualified result sets from large volumes of data. For example, an organization might want to generate a targeted mailing list based on dozens of characteristics. These applications rapidly increase the dimensionality requirements for analysis. Most organizations implementing decision support systems find themselves needing systems that can process and scale to tens, hundreds, and even thousands of zettabytes of atomic information (e.g., information by store, by day, by item, etc.). In particular, decision support systems need to (1) support the complex analysis requirements of decision-makers, (2) analyze the data from a number of different perspectives (i.e. business dimensions), (3) support complex analyses against large input (atomic-level) data sets, and (4) provide near real-time analysis of the data. While existing OLAP systems meet some of the above-listed requirements, they are traditionally batch-based and thus cannot meet the demands of near real-time analysis of large volumes of incoming data streams. Further, since the volume of incoming data is of the order of several zettabytes, within some OLAP systems, the processing step (data load) can be quite lengthy and thus introduce delays and latency. Updating of data can also take a long time depending on the degree of pre-computation. Pre-computation can also lead to what is known as data explosion. Further, OLAP systems typically require vast amounts of memory and processor resources to process the incoming data.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a flow diagram illustrating a process used in some implementations for configurable data stream aggregation.

FIG. 5 is an example illustrating executing data operation on input data stream(s) to generate output data stream(s).

The techniques introduced here may be better understood by referring to the following Detailed Description in conjunction with the accompanying drawings, in which like reference numerals, indicate identical or functionally similar elements.

### DETAILED DESCRIPTION

There exists a need for a decision support system that supports configurable data stream aggregation and overcomes these and other drawbacks of existing decision support systems. A new configurable data stream aggregation system and method is disclosed that processes incoming streams of data such that data barely comes to rest, if it comes to rest at all, before it is processed to generate multiple metrics and aggregates, that are then formatted and streamed in the form of an output data stream. In some implementations, the system receives one or more streams of incoming data and determines their format. One or more of the input data streams can be generated by one or more data sources and can be written to the storage of an intermediate system before they are received by the configurable data stream aggregation system. In some implementations, the input data streams can be stored in data tables before they are received by the configurable data stream aggregation system. The input data streams can be associated with an input stream definition which defines the format and structure of the data in the input stream. For example, an input stream definition can be based on a structure of the data tables storing the input data streams. In some implementations, an input stream definition can be based on a template (e.g., in XML). The input stream definition can define a format of each data field (e.g., numeric, alphanumeric, binary, etc.), a size of the each data field (e.g., number of bits, etc.), valid values of each data field (e.g., values within a certain range, etc.), dependency on other data fields, etc.

The system can also determine output stream definitions of one or more output streams that will be generated after processing the input data streams. The output stream definitions can be based upon one or more aggregate values generated by performing data operations on the input data streams. In some implementations, the aggregate values can be generated by performing data operations on the input data streams and data stored in one or more data tables. For example, an output data stream definition can correspond to a multi-dimensional data set (e.g., cube, hypercube, etc.) that comprises of dimensions and measures. A multi-dimensional data set can display and aggregate large amounts of data while also providing users with searchable access to any data points so that the data can be rolled up, sliced, and diced (analytical operations) as needed to handle the widest variety of questions that are relevant to a user's area of interest. A dimension of the multi-dimensional data set can allow the filtering, grouping, and labeling of data. Examples of dimensions include time-period, region, product identifier, scenario, etc. A measure of the multi-dimensional data set can be numeric values that users want to slice, dice, aggregate, or analyze. Examples of measures include sales, profits, hits per second, clicks per item, expenses, budget, forecast, etc. Measures can be generated by applying business rules and calculations (e.g., data operation functions) on input data streams. Examples of data operation functions include, but are not limited to, sum, count, count listing, minimum, maximum, average, mean, median, mode, etc. Data operation functions can also be user-defined. For example, a user can define a series of data operation functions and/or business rules that can be applied on one or more input data streams to generate one or more custom measure values (“aggregates”).

After the system determines the input stream definition(s) and the output stream definition(s), it can select one or more data operations that will be used to generate the measure/aggregate values in the output stream. The data operations selections can be based upon the data in the input streams and their format (the input stream definitions), as well as the format of the output streams (the output stream definitions). For example, if the input streams comprise click data and advertisement data, and the output stream definition comprises a measure/aggregate of clicks per advertisement, then the system selects the data operation of count (and/or sum) that will be executed on the input streams of data to compute the appropriate values for the clicks per advertisement measure/aggregate in the output stream. In some implementations where the output stream definitions comprise more complex measure/aggregate values, one or more data operation functions (standard and/or user-defined) may be selected based on the input stream definitions. The data operations can also be optimized to ensure that the output data stream(s) are generated more effectively and efficiently. For example, the system can determine an optimized order of execution of the data operations on the input streams of data for faster generation of output stream of data in an output stream data format corresponding to the output stream definition. The selected data operations are then executed on the input data streams to generate one or more measures/aggregates of the output data stream(s) in the output stream format(s). The output data stream(s) can then be streamed to one or more systems (internal or external).

The system can also work in a pluggable manner. For example, for more complex and data intensive output streams, an arrangement (e.g., daisy chain, mesh, etc.) of several configurable data stream aggregation systems can be set-up such that output data stream(s) generated by one or more configurable data stream aggregation systems can be used as input data stream(s) of other downstream configurable data stream aggregation systems. In this manner, each configurable data stream aggregation system can be used to generate measures/aggregates in intermediate output data streams that will be ultimately used to generate complex measures/aggregates in one or more final output data streams.

The disclosed system and method have several advantages. Although several advantages are described in this disclosure, not all advantages are required in each implementation of the system. Also, some advantages will become apparent to those having ordinary skill in the art after reviewing the disclosure. One advantage is that the configurable data stream aggregation system and method can produce output data streams in real-time by performing data operations on input data streams almost as soon as the data in the input data streams is generated. This reduces the lag that currently exists in prior art systems between when data is generated (e.g., when a user clicks on an advertisement) and when meaningful measures/aggregates (e.g., popularity of the advertisement) can be generated based on that data. Further, since the configurable data stream aggregation system can be arranged in a configurable manner, complex measures/aggregates can be generated while optimizing processing capacity and minimizing system failures (e.g., due to processing overload).

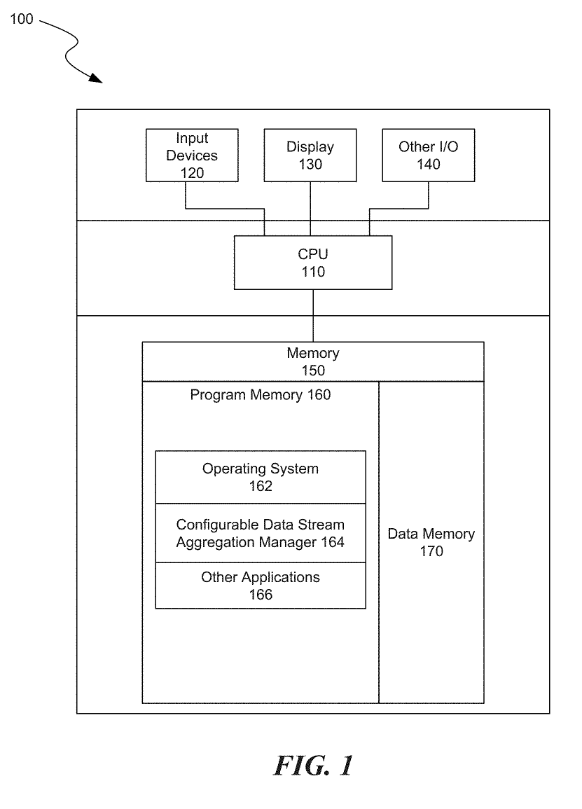

Turning now to the figures, FIG. 1 is a block diagram illustrating an overview of devices on which some implementations of the disclosed technology can operate. The devices can comprise hardware components of a device 100 that performs configurable data aggregation of input data stream(s). Device 100 can include one or more input devices 120 that provide input to the CPU (processor) 110, notifying it of actions. The actions are typically mediated by a hardware controller that interprets source code changes received from the input device and communicates the information to the CPU 110 using a communication protocol. Input devices 120 include, for example, a computer, a laptop, a mobile device (e.g., smartphone, tablets, etc.), or other user input devices.

CPU 110 can be a single processing unit or multiple processing units in a device or distributed across multiple devices. CPU 110 can be coupled to other hardware devices, for example, with the use of a bus, such as a PCI bus or SCSI bus. The CPU 110 can communicate with a hardware controller for devices, such as for a display 130. Display 130 can be used to display text and graphics. In some examples, display 130 provides graphical and textual visual feedback to a user. The display 130 can provide information related to test case scheduling, test case execution, tested commits, untested commits, etc. Examples of display devices are an LCD display screen, an LED display screen, and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The CPU 110 can have access to a memory 150. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; rather a memory is non-transitory. Memory 150 can include program memory 160 that stores programs and software, such as an operating system 162, configurable data stream aggregation manager 164, and other application programs 166. Memory 150 can also include data memory 170 that can include user data such as passwords, usernames, input text, audio, video, user preferences, and selections. Data memory 170 can also include configuration data, settings, user options, time stamps, or session identifiers. Data in memory 170 can be provided to the program memory 160 or any element of the device 100.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, wearable electronics, tablet devices, mobile devices, multiprocessor systems, microprocessor-based systems, set-top boxes, programmable consumer electronics, network PCs, minicomputers, mainframe computers, and distributed computing environments that include any of the above systems or devices, or the like. Special purpose computing system environments or configurations can operate and execute specialized set of instructions to perform the particular actions associated with a configurable data stream aggregation framework.

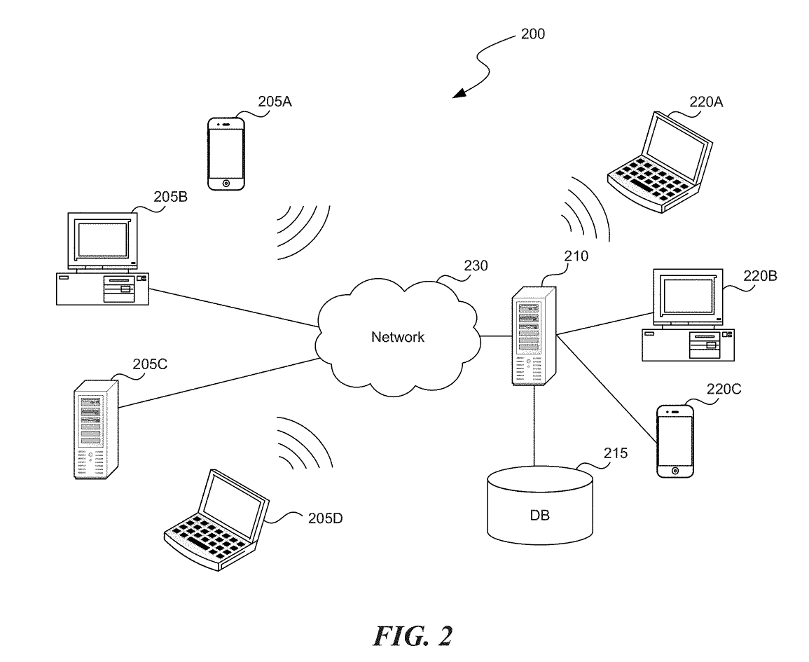

FIG. 2 is a block diagram illustrating an overview of an environment 200 in which some implementations of the disclosed technology can operate. Environment 200 can include one or more client computing devices 205A-D, examples of which can include, but are not limited to, personal computers, server computers, handheld or laptop devices, cellular telephones, wearable electronics, tablet devices, mobile devices, multiprocessor systems, microprocessor-based systems, set-top boxes, programmable consumer electronics, network PCs, minicomputers, mainframe computers, and distributed computing environments that include any of the above systems or devices, or the like. Client computing devices 205A-D can comprise computing systems, such as device 100. The input data stream(s) can be generated by on one or more client computing devices 205A-D and transmitted, through network 230, to one or more computers, such as a server computing device 210. A server computing device 210 can comprise computing systems, such as device 100. Though the server computing device 210 is displayed logically as a single server, server computing devices can each be a distributed computing environment encompassing multiple computing devices located at the same or at geographically disparate physical locations. In some implementations, each server computing device 210 corresponds to a group of servers. The server computing device 210 can connect to a database 215. In some implementations, a server computing device 210 can be a web server or an application server. As discussed above, each server computing device 210 can correspond to a group of servers, and each of these servers can share a database or can have their own database. Database 215 can warehouse (e.g. store) information such as the input data stream(s), input data stream definition(s), output data stream(s), output data stream definition(s), previously computed aggregates, other supporting information, etc. Though database 215 is displayed logically as a single unit, it can be a distributed computing environment encompassing multiple computing devices, can be located within its corresponding server, or can be located at the same or at geographically disparate physical locations.

Server computing device 210 can be connected to one or more devices 220A-C. The output data stream(s) can be transmitted to devices 220A-C. Examples of devices 220A-C include, but are not limited to, smartphones, tablets, laptops, personal computers, etc. Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. Although the connections between server 210 and devices 220 are shown as separate connections, these connections can be any kind of local, wide area, wired, or wireless network, including network 230 or a separate public or private network.

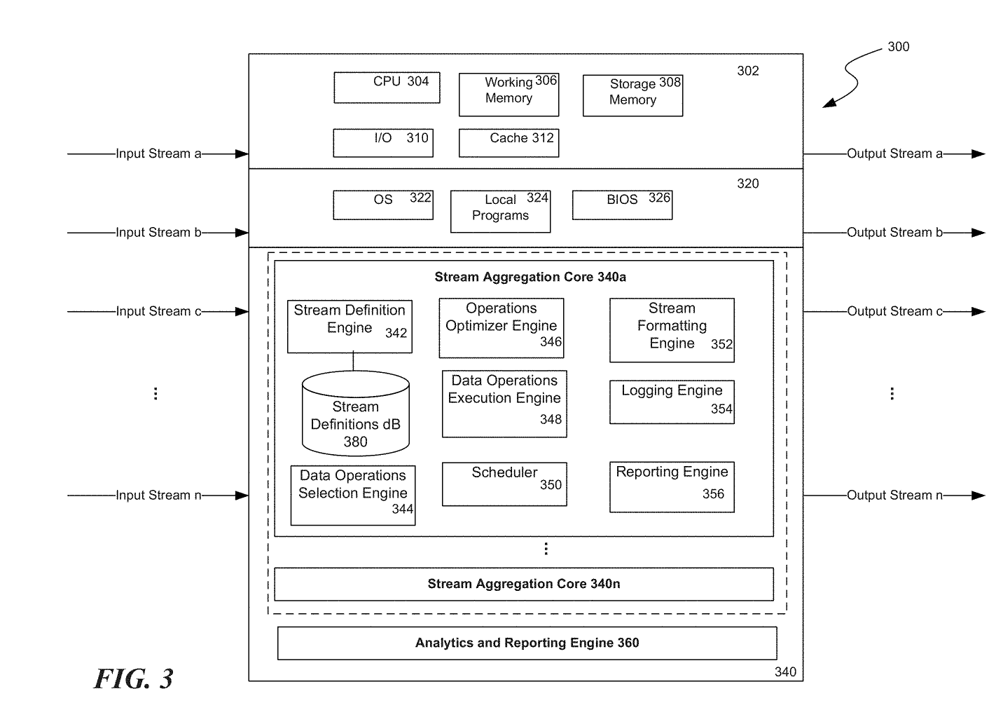

FIG. 3 is a block diagram illustrating components 300 which, in some implementations, can be used in a system employing the disclosed technology. The components 300 can receive and process one or more input streams Input Stream a, Input Stream b . . . Input Stream n and output one or more output data streams Output Stream a, Output Stream b . . . Output Stream n. The components 300 include hardware 302, general software 320, and specialized components 340. As discussed above, a system implementing the disclosed technology can use various hardware including central processing units 304, working memory 306, storage memory 308, and input and output devices 310. Components 300 can be implemented in a client computing device such as client computing devices 205 or on a server computing device, such as server computing device 210.

General software 320 can include various applications including an operating system 322, local programs 324, and a basic input output system (BIOS) 326. Specialized components 340 can be subcomponents of a general software application 320, such as local programs 324. Specialized components 340 can include one or more stream aggregation cores 340a . . . 340n. Each stream aggregation core can include stream definition engine 342, stream definitions database 380, data operations selection engine 344, data operations optimizer engine 346, data operations execution engine 348, scheduler 350, stream formatting engine 352, logging engine 354, and reporting engine 356. Specialized components 340 can also include analytics and reporting engine 360. In general, all or some of the specialized components of a stream aggregation core 340a can be included in the configurable stream aggregation manager 164 (as shown in FIG. 1).

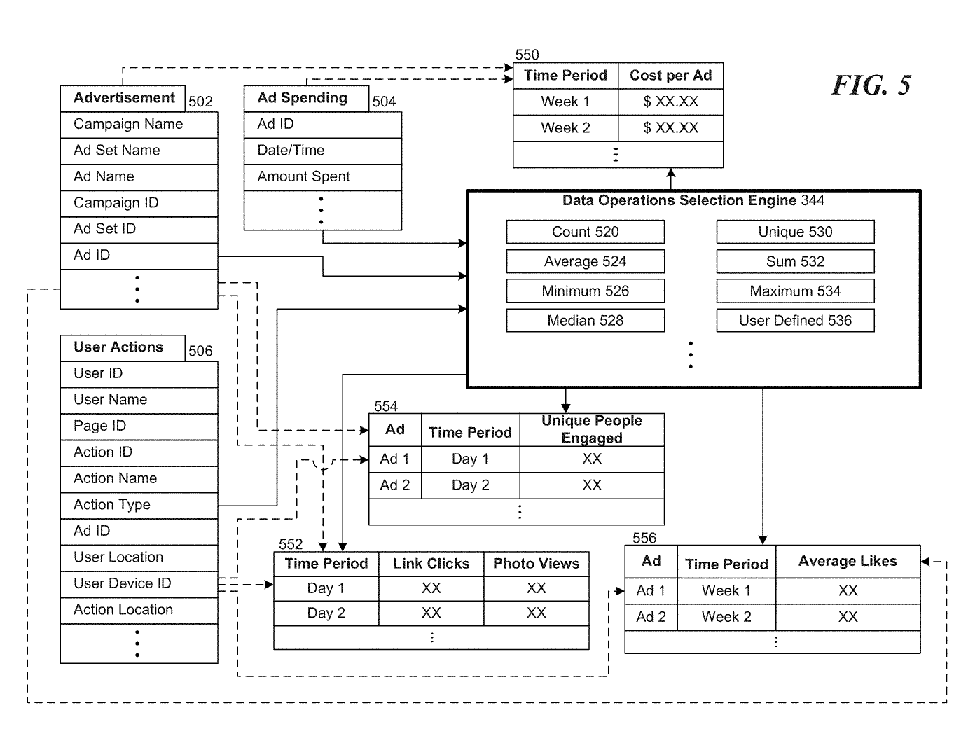

Input data streams Input Stream a, Input Stream b . . . Input Stream n comprise data values that can be used to generate one or more measures/aggregates based on one or more data operations. For example, in an advertisement reporting application, input data streams can comprise data values related to advertisements, link clicks, post likes, comments, shares, photo views, video views, offer claims, check-ins, application installs, credit spends, website checkouts, website leads, searches, ratings submitted, add to cart, add to wish list, purchases, etc. Examples of input data streams and their corresponding definitions are illustrated in FIGS. 5 (502, 504, and 506). Output streams in an advertisement reporting application can comprise measures/aggregate data values such as impressions, cost per 1000 impressions, reach, frequency, deliver, social reach, social impressions, actions, people taking action (e.g., average likes, link clicks, photo views, etc.), relevance score, positive feedback, negative feedback, amount spent, amount spent per time period, user engagement, link clicks, etc. Examples of output data streams and their corresponding definitions are illustrated in FIGS. 5 (550, 552, 554, and 556).

Stream definition engine 342 can be configured to manage definitions of data streams (Input Stream a, Input Stream b . . . Input Stream n and Output Stream a, Output Stream b . . . Output Stream n). The definitions of data streams can be based on the structures of one or more tables that store data of the corresponding data stream (e.g., as illustrated in FIGS. 5, 502, 504, and 506). In some implementations, an input stream definition can be based on a template (e.g., in XML). The input stream definition can define a format of each data field (e.g., numeric, alphanumeric, binary, etc.), a size of the each data field (e.g., number of bits, etc.), valid values of each data field (e.g., values within a certain range, etc.), dependency on other data fields, etc. Output stream definitions can be based upon one or more aggregate values generated by performing data operations on the input data streams (e.g., as illustrated in FIGS. 5, 550, 552, 554, and 556). The definitions of data streams can be stored in a stream definitions database 380. The stream definitions database 380 can be local to each stream aggregation core 340a, or can be shared by two or more stream aggregation cores. In some implementations, the stream definitions database 380 can be part of the database 215 illustrated in FIG. 2.

Data operations selection engine 344 can be configured to select one or more data operations to operate on the input data stream(s) in order to generate output data stream(s) in output stream data format(s). The data operations can be based upon the data in the input streams and their format (the input stream definitions), as well as the format of the output streams (the output stream definitions). For example, if the input streams comprise user actions data and advertisement data, and the output stream definition comprises a measure/aggregate of clicks per item (e.g. video, photo, social media post, charitable institution message, recipe), then the data operations selection engine 344 selects the data operation of count (and/or sum) that will be executed on the input streams of data to compute the appropriate values for the clicks per item measure/aggregate in the output stream. As another example, if the input streams comprise item data and item spending data, and the output stream definition comprises a measure/aggregate of cost per item, then the data operations selection engine 344 selects the data operation of sum that will be executed on the input streams of data to compute the appropriate values for the cost per ad measure/aggregate in the output stream. In some implementations where the output stream definitions comprise more complex measure/aggregate values, one or more data operation functions (standard and/or user-defined) may be selected based on the input stream definitions.

Data operations optimizer engine 346 can be configured to optimize the data operations to be performed on the input data streams to ensure that the output data stream(s) are generated more effectively and efficiently. For example, the data operations optimizer engine 346 can determine an optimized order of execution of the data operations on the input streams of data for faster generation of an output stream of data in an output stream data format corresponding to the output stream definition. In some implementations, the data operations optimizer engine 346 can identify dependencies between various data values in output data stream(s) and determine a minimum set of data operations and their order to generate data values in the output data streams. For example, if an operation (e.g., operation A) is needed to create two different data values (measures/aggregates) in output data stream(s), the data operations optimizer engine 346 can identify this commonality based on the input stream definition(s) and the output stream definition(s) such that the results of operation A are stored (e.g., in memory, cache, database, etc.) when computing the data value for the first aggregate, and then using the stored result when computing the data values for the second aggregate. Similarly, if a data value for a first measure/aggregate can be used to determine a data value for a second measure/aggregate, the data operations optimizer engine 346 can identify this dependency and optimize the data operations accordingly (e.g., by first scheduling for execution data operation(s) to generate the first measure/aggregate, and then scheduling for execution data operation(s) to generate the second measure/aggregate based on the computed first measure/aggregate).

Data operations execution engine 348 can be configured to execute the selected and/or optimized data operation(s) in the order determined by the data operations optimizer engine 346. Scheduler 350 can be configured to schedule execution of data operations. For example, scheduler 350 can schedule data operations for execution as soon as an input data stream is received, after a predetermined time interval has elapsed after an input data stream is received, at the end of the day, at specific times during the day, etc. Stream formatting engine 352 can format the data values generated upon execution of the data operations on the input data stream(s) into output stream(s) of data in the output stream data format(s). Logging engine 354 can maintain a log of data operation(s) scheduling and execution including details such as, input data stream(s) processed, input data stream definition(s), data operation(s) selected, data operation(s) executed, order of data operation(s), schedule timestamp, expected execution timestamp, actual execution timestamp, total execution time, execution result, etc. Reporting engine 356 can be configured to perform analytics and reporting functions related to data operation(s) scheduling and execution. In some implementations multiple stream aggregation cores can process data received from input data stream(s) and/or other data sources (e.g., using synchronous data lookups) and generate data values for the same (and/or different) output data stream(s). Analytics and reporting engine 360 can generate predefined, user defined, and/or ad hoc reports and analytical results based on data values in one or more output data stream(s).

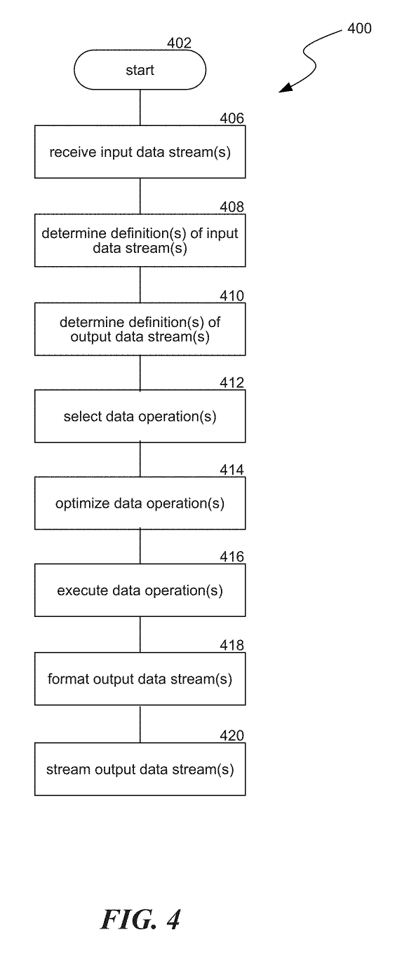

FIG. 4 is a flow diagram illustrating a process 400 used in some implementations for configurable data stream aggregation. Process 400 begins at block 402 and continues to block 406. At block 406, process 400 receives and processes an input data stream. An input data stream can comprise one or more individual data streams. Input data streams can be received from one or more sources, such as, user devices, servers, databases, storage devices, etc. In some implementations, data (e.g., data related to user actions (e.g., likes, views, share, comment, etc.)) barely comes to rest (e.g., stored in a memory device, database, etc.), if it comes to rest at all, before it is received as an input stream by process 400. At block 408, process 400 determines input stream definition of the received input data stream. The input stream definitions can be based on the structures of one or more tables that can store data of the corresponding input data stream (e.g., as illustrated in FIGS. 5, 502, 504, and 506). In some implementations, an input stream definition can be based on a template (e.g., in XML). The input stream definition can define a format of each data field (e.g., numeric, alphanumeric, binary, etc.), a size of the each data field (e.g., number of bits, etc.), valid values of each data field (e.g., values within a certain range, etc.), dependency on other data fields, etc.

At block 410, process 400 determines output stream definition for one or more output data streams. Output stream definitions can correspond to one or more aggregate values generated by performing data operations on the input data streams (e.g., as illustrated in FIGS. 5, 550, 552, 554, and 556). For example, for output stream 552, process 400 can determine the corresponding output stream definition by determining the data values comprising the output stream (time period key, link clicks aggregate value, and photo views aggregate value) as well the data operations that need to be performed on the input data streams (user actions data stream and advertisement data stream), as well as data available from other sources, such as data stored in memory, database, etc., to compute the aggregate values in the output data stream. At block 412, process 400 selects one or more data operations to operate on the input data stream(s) in order to generate one or more aggregate values in the output data stream(s) in output stream data format(s). The selected data operations can be based upon the data in the input streams and their format (the input stream definitions), as well as the format of the output streams (the output stream definitions). For example, as illustrated in FIG. 5, for output data stream 550, which comprises time period and cost per advertisement (measure/aggregate), process 400 selects data operation sum 532 and input data streams advertisement 502 and advertisement spending 504 in order to generate measure/aggregate data values of cost per advertisement per time period.

At block 414, process 400 optimizes the selected data operations based upon one or more factors and/or parameters (e.g., minimize processing time, minimize processing capacity, minimize dependencies, execute a particular data operation first/last, etc.). At block 416, the data operations are executed to generate measure/aggregate data values of the output stream of data. At block 418, process 400 formats the generated data values in the output data stream based upon the output stream definition (e.g., key measure-aggregate value pairs). The output data stream is then streamed to one or more systems, at block 420. In some implementations, the output data stream is streamed to another configurable data stream aggregation core (e.g., FIG. 3, 340a) such that one or more of blocks 406-420 of process 400 can be repeated in a plug-and-play manner.

FIG. 5 is an example illustrating executing data operations on input data stream(s) to generate output data stream(s). Example 500 begins with the receipt of one or more input data streams 502, 504, and 506. Input data stream 502 comprises data related to advertisements, such as, campaign name (alphanumeric), advertisement set name (alphanumeric), advertisement name (alphanumeric), campaign identifier (numeric), advertisement set identifier (numeric), advertisement identifier (numeric), active (is the advertisement active or not) (Boolean), etc. Input data stream 504 comprises data related to advertisement spending, such as, advertisement identifier (numeric), date/time (date time), amount spent (numeric), etc. Input data stream 506 comprises data related to user actions, such as, user identifier (numeric), user name (alphanumeric), page identifier (page where user action occurred) (alphanumeric), action identifier (numeric), action name (alphanumeric), action type (e.g., like, comment, share, click, view, etc.) (alphanumeric), advertisement identifier (numeric), user location (e.g., geographic location of the user) (alphanumeric), user device identifier (e.g., desktop, mobile device, etc.) (numeric), action location (e.g., location of action on a page) (alphanumeric), etc. Data operations selection engine 344 (FIG. 3), which comprises one or more data operations, such as, count 520, average 524, minimum 526, median 528, unique 530, sum 532, maximum 534, user defined function 536, etc., selects one or more data operations that can be executed on one or more of the input data streams to generate data values corresponding to the output data streams 550, 552, 554, and 556.

For example, for output data stream 550, which comprises time period and cost per advertisement (measure/aggregate), data operations selection engine 344 selects data operation sum 532 and input data streams advertisement 502 and advertisement spending 504 to compute data values of cost per advertisement per time period. Data operations execution engine (FIG. 3, 346) can then execute the data operation sum 532 on input data streams advertisement 502 and advertisement spending 504 and can group the data by the selected time period (e.g., weekly) to generate data values of cost per advertisement per time period for output data stream 550. Similarly, for output data stream 552, which comprises time period (daily), link clicks, and photo views, data operations selection engine 344 selects data operation count 520 and input data streams advertisement 502 and user actions 506 to compute data values of link clicks and photo views. Similarly, for output data stream 554, which comprises advertisement, time period (daily), and unique people engaged, data operations selection engine 344 selects data operations count 520 and unique 530, as well as input data streams advertisement 502 and user actions 506 to compute data values of unique people engaged per advertisement per day (grouping by advertisement and time period). For output data stream 556, which comprises advertisement, time period (weekly), and average likes, data operations selection engine 344 selects data operations average 524, as well as input data streams advertisement 502 and user actions 506 to compute data values of average likes and group by time period (weekly). In this manner, data operations selection engine 344 can select one or more data operations based on the input stream definition(s) and the output stream definition(s).

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the implementations. Accordingly, the implementations are not limited except as by the appended claims.

Reference in this specification to “one implementation,” “an implementation,” or “some implementations” means that a particular feature, structure, or characteristic described in connection with the implementation is included in at least one implementation of the disclosure. The appearances of the phrase “in some implementations” in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various implementations given in this specification.

Those skilled in the art will appreciate that the logic illustrated in each of the flow diagrams discussed above may be altered in various ways. For example, the order of the logic may be rearranged, substeps may be performed in parallel, illustrated logic may be omitted; other logic may be included, etc.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Without intent to further limit the scope of the disclosure, examples of instruments, apparatus, methods and their related results according to the implementations of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

I/We claim:

1. A method performed by a computing device for aggregating data, comprising:
receiving one or more input streams of data;
determining an input stream definition for each of the one or more input streams of data, wherein each input stream definition is based on a structure of one or more tables storing data of the input stream of data;
determining an output stream definition for an output stream of data, wherein the output stream definition is based on a determined structure of at least one aggregate, the at least one aggregate comprising data values derived from the input stream of data;
selecting one or more data operations, based on the input stream definition, that will generate the data values of the output stream of data in an output stream data format corresponding to the output stream definition;
executing the one or more data operations on the input stream of data to generate the output stream of data in the output stream data format; and
streaming the output stream of data.

2. The method of claim 1 wherein each input stream of data is stored in the one or more tables prior to receiving the respective input stream of data.

3. The method of claim 1 further comprising optimizing, based on the input stream definitions, the one or more data operations prior to executing.

4. The method of claim 3, wherein the optimizing further comprises determining an order to execute the one or more data operations.

5. The method of claim 3, wherein the optimizing further comprises:
executing a first data operation on the input stream of data to generate a first data value; and
executing a second data operation on the first data value to generate a second data value, wherein the output stream of data comprises the second data value.

6. The method of claim 1 wherein the input stream is one of multiple input streams and the method further comprises:
identifying a subset of the multiple input streams of data to generate data values of the output stream of data.

7. The method of claim 1 wherein streaming the output stream of data is based on a predetermined schedule.

8. The method of claim 1 wherein the one or more data operations are based on a user-defined function.

9. The method of claim 1 further comprising performing one or more reporting operations on the output stream of data, wherein the one or more reporting operations generate a set of reports comprising a subset of the data values of the output stream of data.

10. The method of claim 1 further comprising performing one or more analytical operations on the output stream of data, wherein the one or more analytical operations comprise one or more of:
slice and dice,
drill down,
roll-up,
pivot, or
any combination thereof.

11. The method of claim 1, wherein a first input data stream is based on a structure of a first table storing data, and a second input data stream is based on a structure of a second table storing data, wherein the first table is different than the second table.

12. The method of claim 1 wherein the data operation comprise one or more of:
sum,
count,
count listing,
minimum,
maximum,
average,
mean,
median,
mode, or
any combination thereof.

13. A system for aggregating data, the system comprising:
one or more processors;
a memory;
a first interface configured to receiving at least one input stream of data;
a stream definition engine configured to:
determining one or more input stream definitions for each of the at least one input stream of data;
determining an output stream definition for an output stream of data, wherein the output stream definition is based on a determined structure of at least one aggregate, the at least one aggregate comprising data values derived from the input stream of data;
an operations selection engine configured to selecting, based on the one or more input stream definitions and the output stream definition, one or more data operations that will transform the input stream of data into one or more data values that match the structure of the at least one aggregate;
an operations execution engine configured to executing the one or more data operations on the at least one input stream of data to generate the one or more data values in the output stream of data; and
a second interface configured to streaming the output stream of data, wherein the output stream of data is used to create or update the at least one aggregate.

14. The system of claim 13 wherein each input stream of data is stored in the one or more tables prior to receiving the respective input stream of data.

15. The system of claim 13 further comprising a data operations optimizer engine configured to optimize, based on the input stream definitions, the one or more data operations prior to executing.

16. The system of claim 1 further comprising an analytics and reporting engine configured to perform one or more analytical operations on the output stream of data, wherein the analytical operations is one or more of:
slice and dice,
drill down,
roll-up,
pivot, or any combination thereof.

17. The system of claim 16 wherein the output stream of data is streamed as an input stream of data to a second system for aggregating data.

18. The system of claim 13 wherein the data operation is one or more of:
sum,
count,
count listing,
minimum,
maximum,
average,
mean,
median,
mode, or
any combination thereof.

19. A computer-readable storage medium storing instructions that, when executed by a computing system, cause the computing system to perform operations for aggregating data, the operations comprising:
receiving an input stream of data;
determining a definition of the input stream of data, wherein the input stream definition corresponds to one or more data structures storing data of the input stream of data;
determining a definition for an output stream of data, wherein the output stream definition is based on one or more aggregates in the output stream of data, the at least one aggregate comprising data values derived from the input stream of data;
selecting a set of data operations, based on the input stream definition, wherein executing data operations in the set of data operations will generate the aggregates in the output stream of data in an output stream data format corresponding to the output stream definition;
executing the data operations in the set of data operations on the input stream of data to generate the aggregates in the output stream of data in the output stream data format; and
streaming the output stream of data.

20. The computer-readable storage medium of claim 19, wherein the operations further comprise optimizing, based on the input stream definitions, the one or more data operations prior to executing, wherein the optimizing further comprises:
executing a first data operation on the input stream of data to generate a first data value; and
executing a second data operation on the first data value to generate a second data value, wherein the output stream of data comprises the second data value.
